(19) United States
(12) Patent Application Publication
(10) Pub. No.: US 2006/0150948 A1
(43) Pub. Date: Jul. 13, 2006

(54) Rotary internal combustion engine

(76) Inventor: Alessandro Pontiggia, Milan (IT)

Correspondence Address: WOLF BLOCK SCHORR AND SOLIS-COHEN LLP, 250 PARK AVENUE, NEW YORK, NY, 10177, US

(21) Appl. No.: 10/561,717

(22) PCT Filed: Jun. 14, 2004
(86) PCT No.: PCT/EP04/06374

§ 371 Date: Dec. 22, 2005

(30) Foreign Application Priority Data
Jun. 24, 2003 (IT) MI2003 A 001283

(51) Int. Cl. F02B 53/00

(52) U.S. Cl. 123/241

(57) ABSTRACT

A rotary engine comprising a stator and a rotor, in which the stator presents a chamber the surface of which presents circular symmetry about a stator axis and the rotary presents an axis of rotation eccentric to the stator axis and is formed from a body which is torsionally rigid with an output shaft, and of which the envelope presents circular symmetry about the axis of rotation, said envelope being similar to the stator chamber.

The present invention relates to a rotary internal combustion engine.

Reciprocating engines have long been commercially available. These engines utilize the well-known connecting rod-crank linkage to transform the reciprocating movement of the piston, impressed by a series of explosions of an air/fuel mixture within a cylindrical chamber In which said piston slides, into a continuous rotary movement usable for the most varied applications. By connecting these engines to alternators, couplings and mechanical members in general, a wide range of activities can be performed, ranging from electrical energy generation to driving mechanical vehicles, etc.

Reciprocating internal combustion engines present undoubted advantages, but also disadvantages. In this respect, their overall efficiency, whether diesel cycle or otto cycle engines, is very low. Essentially, a part of the useful thermodynamic power is dispersed both to operate the complex valve control systems and the valves themselves, and because of kinematic defects inherent in the connecting rod-crank system, such as dead centres and a piston speed which varies substantially between the bottom dead centre and the top dead centre, hence involving energy wastage for accelerating and decelerating the piston.

To eliminate the problems arising from the connecting rod-crank linkage, rotary engines have been developed, of which the most widespread is that commonly known as the Wankel engine. In this type of engine, the rotor acts as a piston and, provided with lobes acting as explosion chambers, is directly in contact with the stator walls; the rotor moves within the stator with planetary motion imposed on it by a pair of gearwheels, of which the first is concentric to and rigid with the rotor, while the second is concentric to the output shaft and rigid with the stator. A problem of the Wankel power unit is the radial seal of the stator-rotor system, which is obtained by U-shaped vanes mounted in suitable grooves parallel to the drive axis, and which are considerably stressed because the kinematics of the rotor movement and the particular shape of the stator. Moreover the Wankel engine involves fairly complex kinematics and is not easy to construct and maintain.

Both in the reciprocating engine and in the Wankel engine the fuel-air mixture is compressed at each cycle; in the former the compression stage directly follows the intake stage. In the latter the intake stage is also followed by the compression stage, compression being determined by the orbital movement which the rotor undergoes relative to the stator. The compression ratio is predetermined both for the former and for the latter engine, and cannot be varied other than by mechanical adjustments to the dimensions of the moving members, such as the connecting rod or the crank in the former case or the dimension of the gearing on the output shaft or on the rotor in the latter. In particular, the compression ratio can be increased in both types of engine for example by suitable compressors, possibly of radial turbine type, to increase the pressure of the intake gas, however it cannot be decreased.

The technical aim of the present invention is therefore to provide a rotary engine by which the stated technical drawbacks of the known art are eliminated, including vibration.

Within the scope of this technical aim, an object of the invention is to provide a rotary engine without dead centres, which is simple and economical, and of small dimensions and low weight compared with conventional internal combustion engines.

Another object of the present invention is to provide a rotary engine which enables the engine compression ratio to be chosen by simply varying the intake gas pressure, without any mechanical constraints imposed by the engine kinematics.

Another object of the invention is to provide a rotary engine which is substantially simple, safe and reliable.

The technical aim, together with these and further objects are attained according to the present invention by a rotary engine in accordance with the accompanying claims.

Further characteristics and advantages of the invention will be more apparent from the description of a preferred but non-exclusive embodiment of the rotary engine according to the present invention, illustrated by way of non-limiting example in the accompanying drawings, in which:

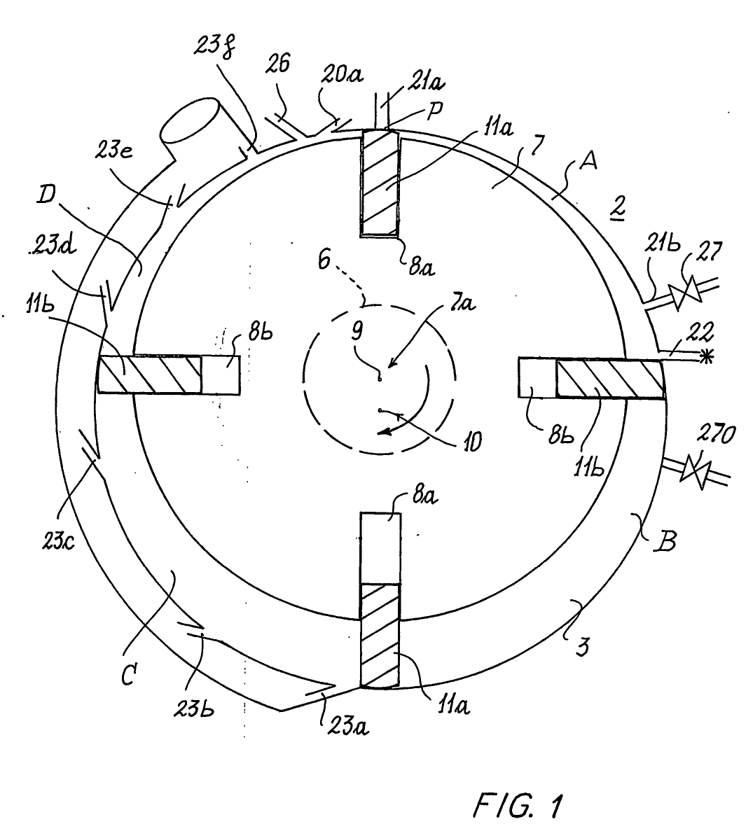

FIG. 1 is a simplified schematic section through the stator/rotor unit of a preferred embodiment of the rotary engine of the present invention;

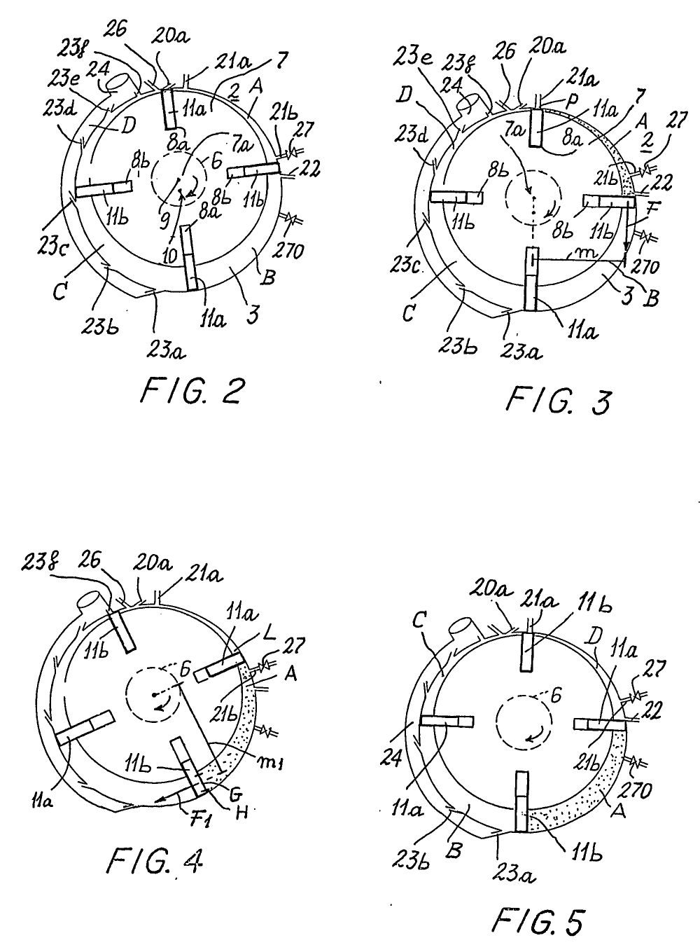

FIGS. 2-9 are simplified schematic views showing the various stages of the is operating cycle of the engine of FIG. 1;

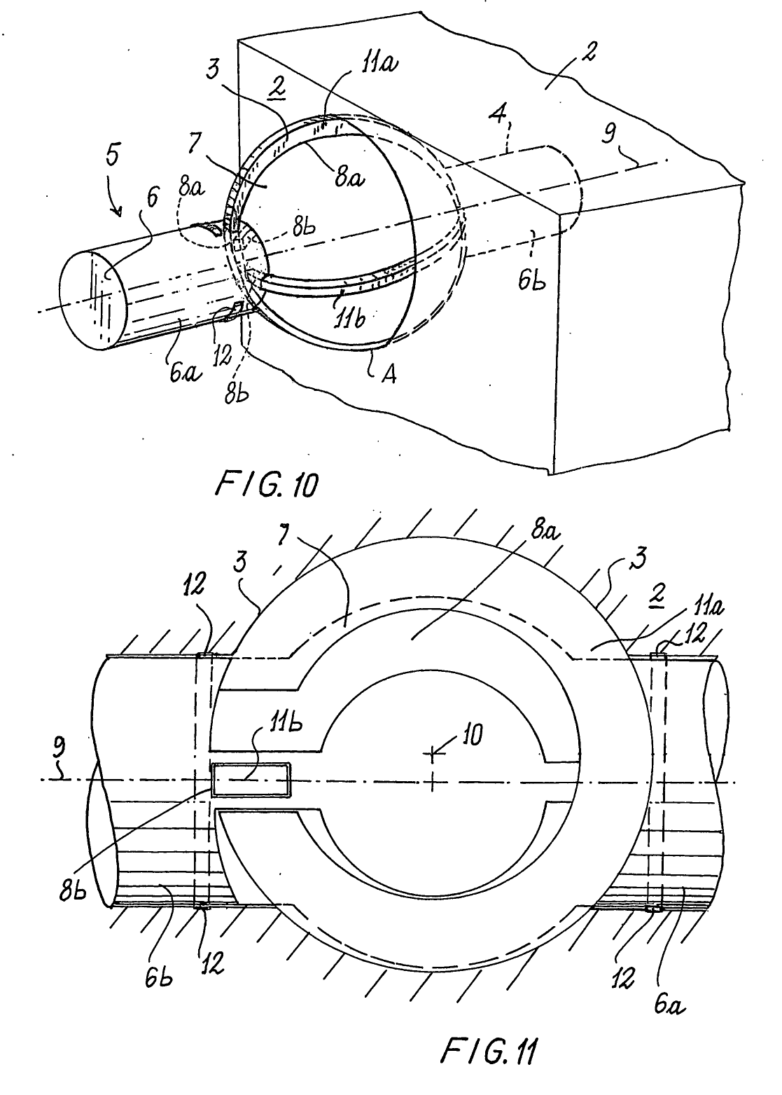

FIG. 10 is a simplified perspective view of the stator/rotor unit of the present rotary engine with some parts enlarged;

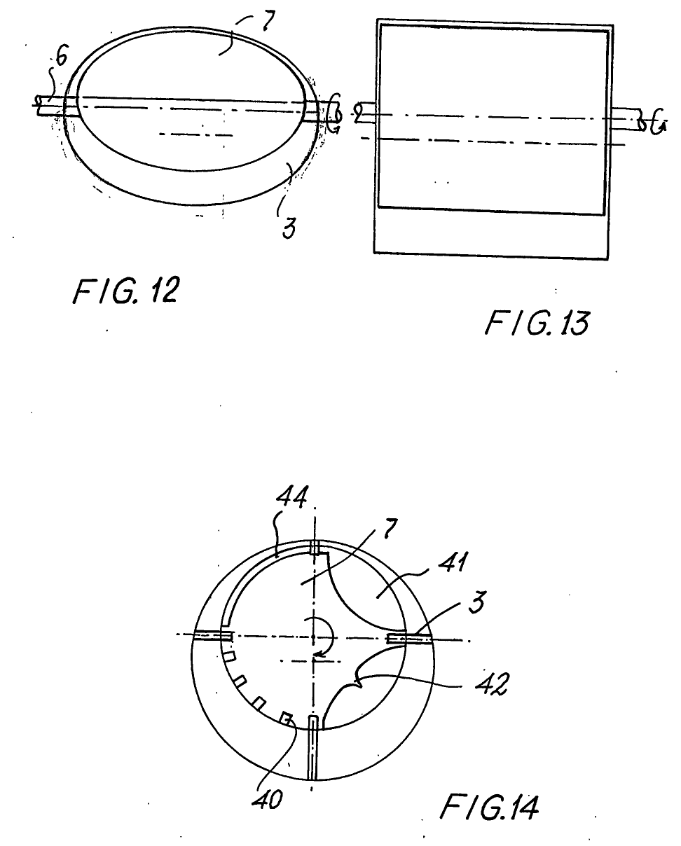

FIG. 11 is a section through the engine of the present invention;

FIGS. 12, 13, 14, 15 show various embodiments of the engine of the present invention;

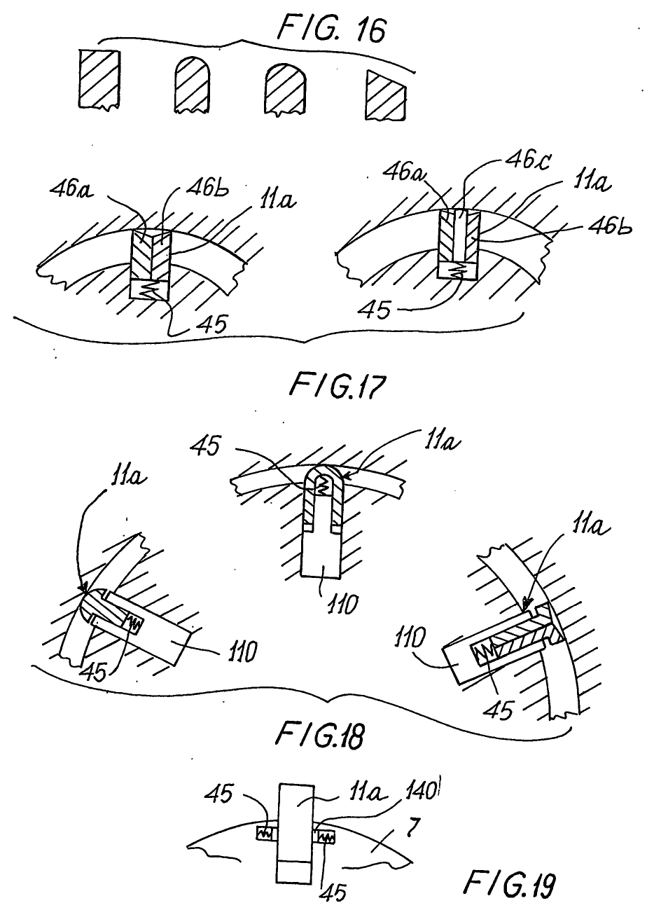

FIGS. 16, 17, 18 show various embodiments of parts of the rotary engine of the present invention;

FIG. 19 shows different embodiments of parts of the engine of the present invention; and

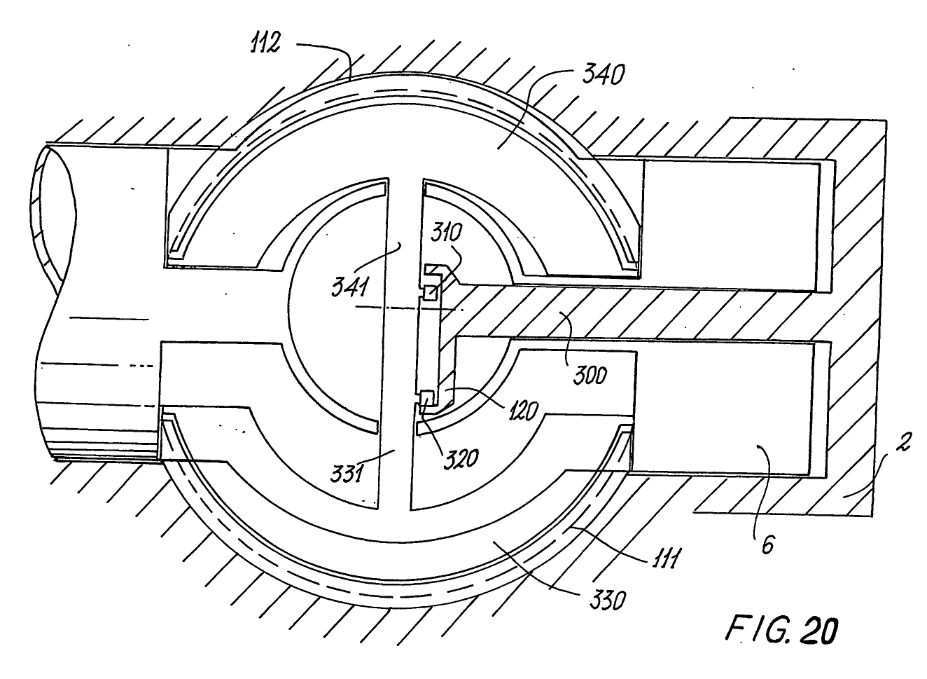

FIG. 20 shows a different embodiment of the rotary engine.

With reference to the said figures, and in particular to FIG. 1, these show a rotary engine indicated overall by 1.

A stator body 2 presents in its interior a substantially spherical chamber 3 and a cylindrical cavity 4, which traverses the stator body 2 but is not aligned with the axis 10a, on which the centre 10 of the spherical chamber 3 lies, this latter acting as a housing and guide for a rotor 5 comprising a output shaft 6, torsionally rigid with a substantially spherical member 7 (similar to but of smaller diameter than the spherical chamber 3) the envelope of which presents substantially spherical symmetry about the axis of rotation 9. The stator body 7 is housed within the chamber 3, the geometry of the chamber 3 and of the cylindrical cavity 4 of the stator 2 being such that the spherical body 7 grazes the surface of the spherical chamber 3 at a point P. The spherical body 7 presents two surface recesses 8a, 8b disposed 90° apart, they extending in the direction of the axis of rotation 9 of the output shaft 6 and at least partly within the output shaft 6 itself. Specifically, with reference to FIG. 10 the recess 8a passes through the entire output shaft 6 on the left side 6a and only partly enters on the right side, whereas the recess 8b passes through the output shaft on the right side 6b and only partly enters on the left side 6a. Two split seal rings 11a, 11b are housed in the surface recesses 8a, 8b, to slide against the walls of the chamber 3 and create four separate sealed chambers A, B, C, D, each of which is bound lowerly by the surface of the spherical body 7, upperly by the inner surface of the chamber 3, at its sides by suitable seal gaskets 12 positioned between the output shaft 6 and the common regions between the spherical chamber 3 and the cylindrical cavity 4, at the rear by the first split ring 11a and at the front by the second split ring 11b. The split rings 11a, 11b adapt to the inner surface of the spherical chamber 3 to ensure sealing and hence isolate the four separate chambers A, B, C, D from each other.

The output shaft 6 is free to rotate about its axis 9, which is parallel to and fixed with respect to the axis 10a of the stator 2, this rotation causing the separate chambers A, B, C, D to slide relative to the inner surface of the spherical chamber 3, so that with clockwise rotation of the shaft 6, a fixed point on the stator pertains in sequence firstly to the separate chamber A, then to the separate chamber D, then to C and then to B until it returns to form part of the separate chamber A. At fixed points on the inner surface of the spherical chamber 3, the stator 2 presents ports 20a, 21a, b, 22, 23a, b, c, d, e, f, 26, 270 which, with the rotation of the shaft, are connected at any given time to one or other of the separate chambers A, B, C, D.

With reference to FIGS. 3-9, the cycle of this engine can be illustrated in the following manner:

the split ring 11a, dragged by the spherical body 7, closes a scavenging port 20a, further described hereinafter;

a compressed air/fuel mixture is injected via a first feed port 21a; compression can be by any compressor (for example radial);

the split ring 11a, dragged by the spherical body 7, closes the first feed port 21a and a spark plug positioned within the port 22 ignites the mixture present in the chamber A;

the expansion (FIG. 3) generates on the walls of the chamber A a sudden pressure increase, which then creates on the split ring 11b a resultant force F1, this being transferred to the rotor by the split ring 11b itself to create a drive torque on the output shaft 6, with an arm m and modulus m*F;

the expansion proceeds, by which a slightly variable but positive torque is transferred to the output shaft during the whole of this stage. In particular (see FIG. 4) the forces which act on all the walls of the chamber A do not produce a drive torque, whereas of those exerted on the rings 11a, 11b only the resultant F1 of the pressure exerted on the area H of the split ring 11b produces a torque, that exerted on the remaining section G being balanced by that acting on the equal area L of the split ring 11a. The torque acting on the output shaft is consequently m1*F1;

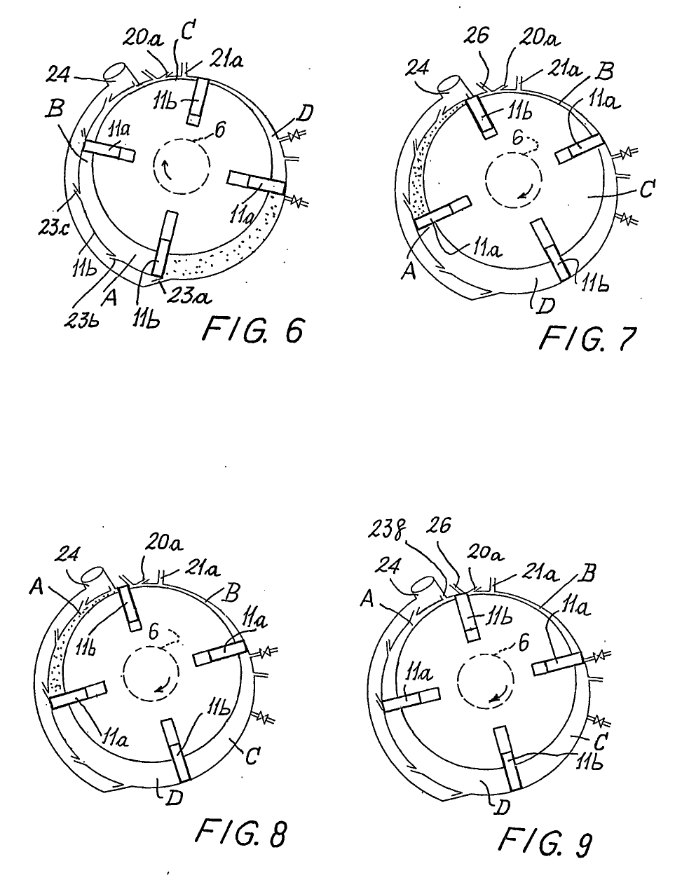

exhaust (FIG. 6) commences when the split ring 11b reaches a first exhaust port 23a, the combustion products being eliminated radially via the exhaust ports 23a, b, c, d, e, f preferably connected together by a main exhaust manifold 24;

scavenging commences with the closure of the exhaust port 23f by the split ring 11b, and with the injection of fresh air via the scavenging port 20a. This injected air expels the residual exhaust gases via the separate scavenging exhaust port 26; the cycle can then recommence.

Specifically, for each revolution of the output shaft 6, four expansions take place, and hence four cycles for each revolution, one cycle for each separate chamber A, D, C, B with virtually continuous combustion which provides a high torque already available at low r.p.m.

The shape, the inclination and the number of ports present on the stator 2 can be varied according to technical requirements related to pressure drops, idling flow rates (for example a port intercepted by a valve 27 can be provided to allow idling without continuous ignition) etc. For example with regard to the exhaust, six ports have been provided. This does not mean that seven or more cannot be provided, to optimize pressure drops during exhaust. In the same manner all or some of the ports 20a, 21a, b, 22, 23a, b, c, d, e, f, 26, 270 can be intercepted by electromechanical or mechanical valves to optimize the cycle stages.

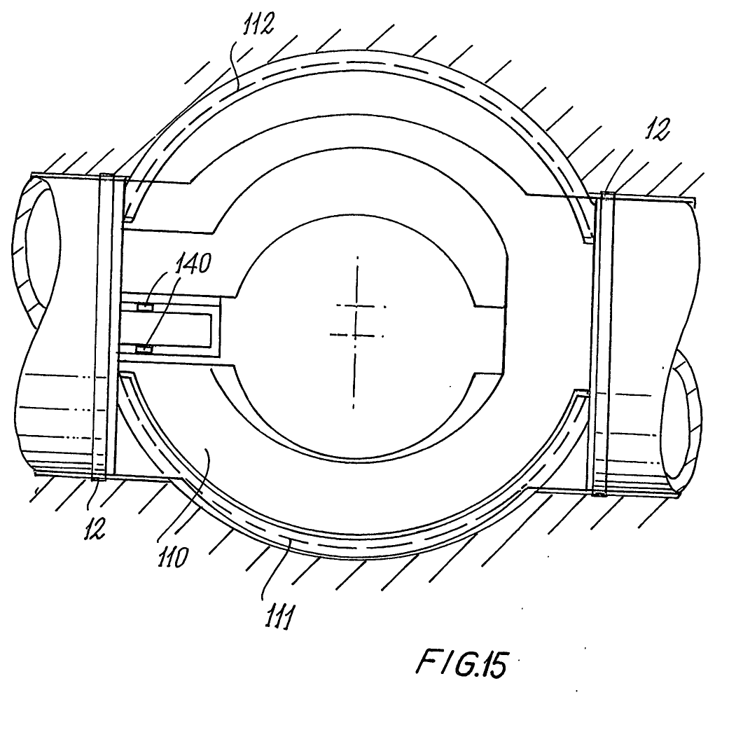

Modifications and variants, in addition to those already stated, are evidently possible, for example the chamber 3 present in the stator 2 and the body 7 torsionally rigid with the output shaft 6 can have different shapes, for example ellipsoidal (FIG. 12) or cylindrical (FIG. 13), hence with an envelope of circular symmetry.

In the same manner the surfaces of the spherical body 7 can present notches 40, recesses 41, protuberances 42, slots 44 to improve engine efficiency or to facilitate combustion of the air/fuel mixture, so that again in this case the envelope maintains circular symmetry.

Again, the seal rings (11a, 11b) can consist of a substantially annular rigid part 110 and two semiannular elastic seal parts 111, 112. This arrangement results in more reliable transmission of the force generated by the gas expansion to the spherical body 7, so that there is no longer the need for compromise between the necessary mechanical strength of said components and the elasticity required to achieve a seal against the Inner surface of the spherical chamber 3.

The shape of the contact surface between the split rings 11a, 11b and the inner surface of the spherical chamber 3 can be varied (FIG. 16), for example it can be square, rounded, bevelled, sharp-edged, etc.

In the same manner the elastic force exerted on the seal rings 11a, 11b can be provided by one or more elastic means 45 acting on said rings (FIG. 17), and said rings 11a, 11b can consist of several layers 46a, b, c possibly of different material.

Moreover, if the seal rings 11a, 11b comprise a rigid annular part 110, elastic means 45 can be interposed between said rigid annular part 110 and the elastic semiannular sealing parts 111, 112 (suitably shaped as in FIGS. 16, 17 and 18), to ensure a sealing force.

In a different embodiment the rigid ring 110 can consist of two rigid half-rings 330, 340 connected together by appendices 331, 341 passing through the spherical body 7. As in the preceding case, these rings comprise semiannular elastic sealing parts 111, 112 disposed at their ends. The appendices 331, 341 are provided with rotary pins 310, 320 which alternately rest on a suitably shaped guide 120 rigid with the stator 2 via a through support 300 concentric with a recess provided in one side of the shaft 6. The half-rings 330, 320 hence discharge the centrifugal force generated by the rotation of the rotor 5 onto the guide 120 instead of onto the inner surface of the stator 2.

FIG. 19 shows, possibly loaded by springs 45, seal means 140 such as gaskets and the like for ensuring sealing by the seal rings 11a, 11b.

A rotary engine conceived in this manner is susceptible to numerous modifications and variants, all falling within the scope of the inventive concept. For example, in a different embodiment the body 7 can act as the stator, with the chamber 3 rotating about its axis 10a.

Moreover all details can be replaced by technically equivalent elements. In practice the materials used, and the dimensions, can be chosen at will according to requirements and to the state of the art.

1. A rotary engine comprising two components, namely a stator, and a rotor torsionally rigid with an output shaft, of said stator and said rotor, a first component presenting a chamber the surface of which presents circular symmetry about an axis of said first component, and a second component being formed from a body which is disposed in the interior of said chamber, and of which the envelope presents circular symmetry about an axis of said second component, said envelope being similar to said chamber, said axes being fixed, mutually parallel and non-aligned, one of said components rotating about its axis, the first component being a stator and the second component being a rotor having a body torsionally rigid with the output shaft, the axis about which the envelope presents circular symmetry being a rotor axis of rotation, said axis being eccentric to the stator axis, the body presenting surface recesses acting as guides for seal means which slide along the surface of the chamber as the body rotates, and which together with the surface of the body and of the chamber define sealed chambers, said chambers “sliding” relative to the surface of the stator chamber as the output shaft rotates, wherein the seal means are split rings.

2. An engine as claimed in claim 1, wherein the stator presents a cylindrical cavity for housing the output shaft.

3. An engine as claimed in claim 2, wherein seal means are present between the cylindrical cavity housing the output shaft and the body.

4. An engine as claimed in claim 1, wherein the chamber present in the stator is substantially spherical with its centre lying on the axis, or is ellipsoidal or cylindrical.

5. An engine as claimed in claim 1, wherein the body has a substantially spherical, ellipsoidal or cylindrical envelope, and has circular symmetry.

6. An engine as claimed in claim 5, wherein the surface recesses are disposed at 90° apart in the direction of the axis of rotation.

7. An engine as claimed in claim 1, further comprising ports are present in the surface of the chamber.

8. An engine as claimed in claim 1, wherein the seal means comprise rigid rings and elastic sealing parts.

9. An engine as claimed in claim 7, wherein the seal means present sliding ends of different shape and materials.

10. An engine as claimed in claim 1, wherein the seal means urged by elastic means, to improve the seal against the surface of the chamber.

11. An engine as claimed in claim 1, wherein the rigid rings present means for discharging the centrifugal force acting on them.

12. An engine as claimed in claim 1, wherein the seal means present further seal means to ensure sealing against the walls of the surface recesses.

13. An engine as claimed in claim 1, wherein the body presents surface notches, recesses, protuberances, or slots to improve engine efficiency.

14. An engine as claimed in claim 7, wherein at least one port is provided with valve means.

15. A method for operating an engine claimed in claim 1, wherein:
with the output shaft rotating, compressed air is injected via a first feed port while fuel is injected via a second feed port, or an air/fuel mixture is injected via only the port;
an ignition means, present in the port, thus ignites the contents of the chamber A;
the mixture expands to create within the chamber A a pressure, the resultant of which is a force which when transferred to the body creates a variable drive torque on the output shaft;
the exhaust gas mixture is discharged when the chamber A, dragged by the rotation of the shaft, communicates with an exhaust port and continues to discharge via subsequent ports.
